(19) United States
(12) Patent Application Publication
(10) Pub. No.: US 2023/0047150 A1
(43) Pub. Date: Feb. 16, 2023

(54) BACKSIDE CHANNEL FLUID RECIRCULATION PATH AND FLUID-EJECTION ELEMENT FLUID RECIRCULATION PATH BACKGROUND

(71) Applicant: Hewlett-Packard Development Company, L.P., Spring, TX (US)

(72) Inventor: Jacob Lum, Corvallis, OR (US)

(73) Assignee: Hewlett-Packard Development Company, L.P., Spring, TX (US)

(21) Appl. No.: 17/794,386

(22) PCT Filed: Jan. 22, 2020
(86) PCT No.: PCT/US2020/014562

§ 371 Date: Jul. 21, 2022

(51) Int. Cl. B41J 2/18

(52) U.S. Cl. CPC B41J 2/18

(57) ABSTRACT

A backside channel is fluidically connected between a supply inlet and a backside outlet. The backside channel has a backside channel fluid recirculation path. An element channel is fluidically connected to an element outlet. Fluid-ejection elements are fluidically connected between the backside channel and the element channel. The fluid-ejection elements have a fluid-ejection element fluid recirculation path.

### BACKGROUND

Printing devices, including standalone printers as well as all-in-one (AIO) printing devices that combine printing functionality with other functionality like scanning and copying, can use a variety of different printing techniques. One type of printing technology is inkjet printing technology, which is more generally a type of fluid-ejection technology. A fluid-ejection device, such as a printhead or a printing device having such a printhead, includes a number of fluid-ejection elements with respective nozzles. Firing a fluid-ejection element causes the element to eject fluid, such as a drop thereof, from its nozzle.

### BRIEF DESCRIPTION OF THE DRAWINGS

FIG. 1A is a top-view diagram of an example fluid-ejection printhead of a fluid-ejection device and through which fluid recirculation can occur via dual fluid recirculation paths. FIGS. 1B and 1C are cross-sectional front view diagrams of the printhead. FIGS. 1D, 1E, and 1F are cross-sectional side view diagrams of the printhead.

FIG. 2 is a diagram of a fluid-ejection device having a printhead with dual fluid recirculation paths.

FIG. 3 is a flowchart of a method for operating a fluid-ejection device having a printhead with dual fluid recirculation paths.

FIGS. 4A and 4B are top-view diagrams of different example topologies for a fluid-ejection printhead having dual fluid recirculation paths.

FIGS. 5A and 5B are top-view diagrams of additional different example topologies for a fluid-ejection printhead having dual fluid recirculation paths.

FIG. 6 is a block diagram of an example fluid-ejection printhead.

FIG. 7 is a block diagram of an example fluid-ejection device.

### DETAILED DESCRIPTION

As noted in the background, a fluid-ejection printhead includes a number of fluid-ejection elements with respective nozzles from which the elements eject fluid, such as by energizing firing resistors of the elements. As printing technology has advanced, the cooling needs for printheads have increased for a variety of different reasons. The density or number of fluid-ejection elements on a given printhead may be particularly great. The rate at which the elements are fired may be particularly high. The power requirements of the firing resistors may likewise be particularly high. The net effect of these and other factors is the generation of unwanted heat within a printhead, resulting in the printhead having to be cooled so as not to affect image formation quality or cause premature printhead failure.

Printing technology advancement has also resulted in printheads being used with more challenging types of fluid, such as printing fluid including ink. Fluids with greater volatility, which is the propensity of the carrier liquid of a fluid to evaporate, leaving being its solid particles, are increasingly used. Fluids that are higher in solid weight percentage, which is the percentage by weight of the solids contained within a fluid, are also used more often. Such fluids are more likely to form viscous plugs at the nozzles of fluid-ejection elements. A plug forms when fluid sufficiently dries out at the nozzle, leaving behind a greater mass of solids that clog the nozzle in the form of a plug. Clogged nozzles can deleteriously affect image quality, by impeding or preventing fluid ejection through the nozzles, and/or by affecting the amount or trajectory of fluid ejected through the nozzles.

Recirculating fluid within a printhead, even when the fluid-ejection elements are in standby and not actively printing, can ameliorate these issues. As to printhead cooling, a printhead may have a backside channel that permits fluid to recirculate at the backside of the fluid-ejection elements. The constantly recirculating fluid absorbs and removes heat generated within the printhead, such as by the firing resistors of the fluid-ejection elements. The same fluid ejected from the printhead can thus provide liquid-cooling functionality.

As to challenging fluid usage, the fluid-ejection elements of a printhead may permit fluid to be recirculated through them. For example, fluid recirculation may occur through a fluid-ejection element's chamber, which contains the fluid that is ejectable through the element's nozzle via firing resistor energization. Such fluid recirculation reduces the likelihood of plug formation by constantly replenishing the fluid located relatively close to the nozzle of a fluid-ejection element, inhibiting the fluid from drying out at the nozzle.

Some printhead architectures permit fluid recirculation just through the backside channel, whereas other architectures permit fluid recirculation just through the fluid-ejection elements. Printhead architectures that permit fluid recirculation through both the backside channel and the fluid-ejection elements provide for such fluid recirculation at flow rates having fixed interdependency. That is, for a given supply pressure of fluid entering a printhead, the flow rate at which fluid recirculates through the backside channel and the flow rate at which fluid recirculates through the fluid-ejection elements are inextricably linked, and cannot be independently set.

This fixed interdependency can limit the usefulness of a printhead having such dual fluid recirculation paths. As one example, increased cooling needs may warrant fluid recirculation through the backside channel of a printhead at a higher flow rate. However, the corresponding increase in fluid recirculation flow rate through the printhead's fluid-ejection elements may be undesirable. This is because recirculating fluid too quickly through the fluid-ejection elements can impair image quality by affecting how fluid is ejected from the chambers of the elements outwards through their nozzles.

Described herein are techniques for dual fluid recirculation paths that can ameliorate these issues. The techniques effectively decouple the flow rate at which fluid recirculation occurs through the backside channel of a fluid-ejection printhead and the flow rate at which fluid recirculation occurs through the fluid-ejection elements of the printhead, and vice-versa. That is, the flow rate through the backside channel fluid recirculation path can be set (e.g., controlled) independently of the flow rate through the fluid-ejection elements, and vice versa.

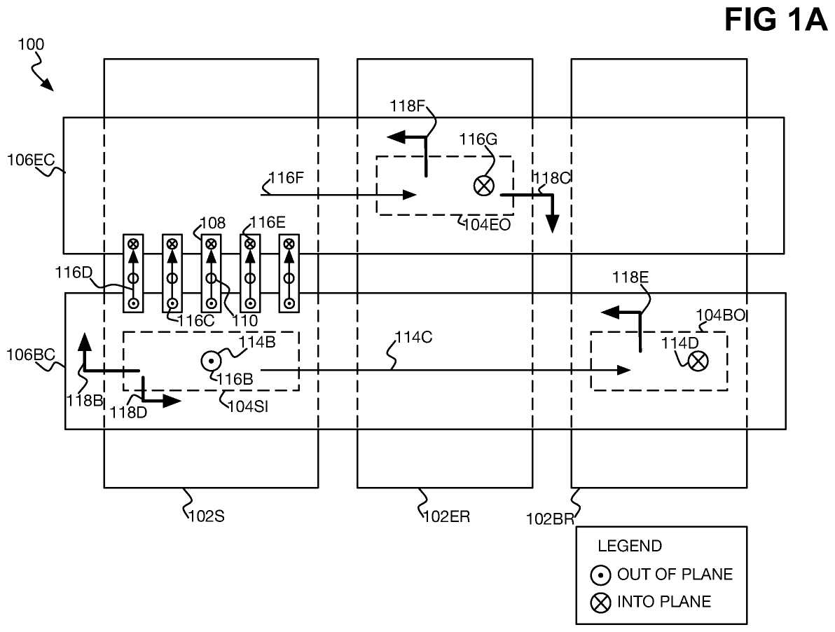

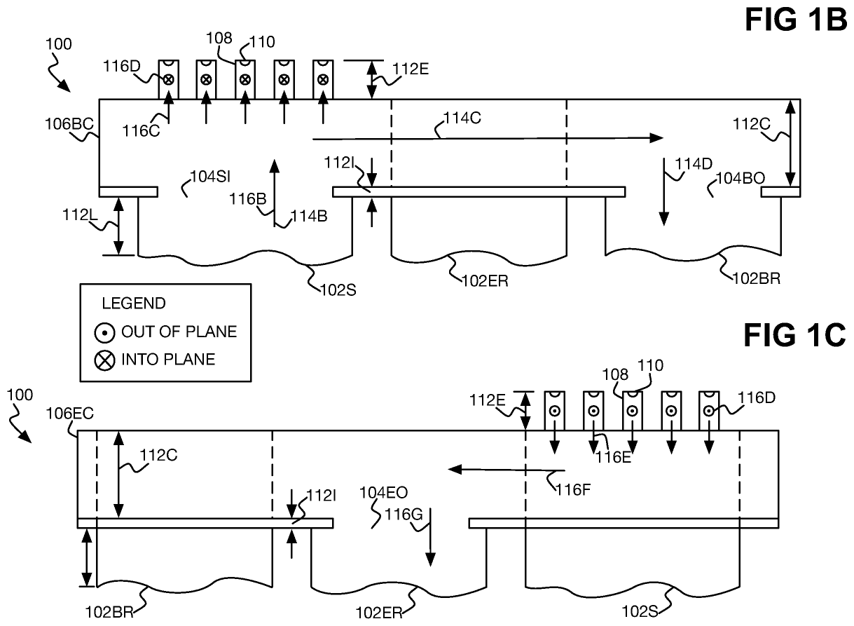

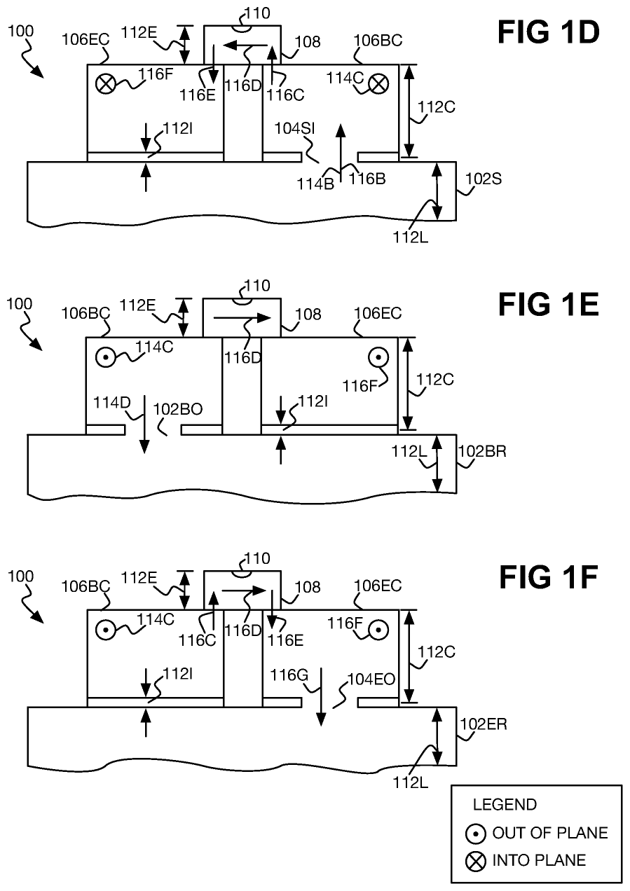

FIG. 1A shows the top-view of an example fluid-ejection printhead 100 of a fluid-ejection device. The printhead 100 includes a fluidic supply slot 102S and two fluidic return slots 102BR and 102ER. The slots 102S, 102BR, and 102ER are collectively referred to as the slots 102. The fluidic supply slot 102S provides fluid to the printhead 100 for ejection and recirculation, whereas the fluidic return slots 102BR and 102ER receives fluid recirculated from the printhead 100. The return slot 102BR is referred to as a backside return slot 102BR, and the return slot 102ER is referred to as an element return slot 102ER.

The printhead 100 includes a backside channel 106BC and an element channel 106EC, which are collectively referred to as the channels 106, and which are disposed over the slots 102. The backside channel 106BC is fluidically connected to the supply slot 102S via a supply inlet 104SI and to the backside return slot 102BR via a backside outlet 104BO. The element channel 106EC is fluidically connected to the element return slot 102ER via an element outlet 104EO. While the printhead 100 is depicted as including one backside channel 106BC and one element channel 106EC, in actual implementation the printhead 100 may likely include multiple backside channels 106BC and multiple element channels 106EC.

The printhead 100 also includes fluid-ejection elements 108 that are disposed over the channels 106. The fluid-ejection elements 108 have respective nozzles 110 through which fluid is ejected from the elements 108 when the elements 108 are fired. Each fluid-ejection element 108 spans and is fluidically connected between the backside channel 106BC and the element channel 106EC. While the printhead 100 is depicted as including five fluid-ejection elements 108, in actual implementation the printhead 100 may likely include more than five elements 108 spanning the pair of channels 106.

The fluid-ejection printhead 100 has a backside channel fluid recirculation path through which fluid recirculates through the backside channel 106BC from the supply slot 102S to the backside return slot 102BR. The fluid recirculation path is defined by fluid flow in the direction of arrows 114B, 114C, and 114D, which are collectively referred to as the arrows 114. Fluid flow out of the plane of FIG. 1 is indicated as an arrow point (i.e., a circled point); fluid flow into the plane of FIG. 1 is indicated an arrow tail (i.e., a circled X or crosshatch).

The backside channel fluid recirculation path may begin with fluid entering the backside channel 106BC from the supply slot 102S via the supply inlet 104SI per the point of arrow 114B. The fluid then flows through the backside channel 106BC in the direction of arrow 114C. The fluid exits the backside channel 106BC into the backside return slot 102BR via the backside outlet 104BO per the tail of arrow 114D, completing the backside fluid recirculation path.

The fluid-ejection printhead 100 also has a fluid-ejection element fluid recirculation path through which fluid recirculates through the fluid-ejection elements 108 from the supply slot 102S to the element return slot 102EO. The fluid recirculation path is defined by fluid flow in the direction of arrows 116B, 116C, 116D, 116E, 116F, and 116G. The fluid-ejection element recirculation path is coincident with the backside channel fluid recirculation path at first; arrow 116B is coincident with arrow 114B.

The fluid-ejection element fluid recirculation path may begin with fluid entering the backside channel 106BC from the supply slot 102S via the supply inlet 104SI per the point of arrow 116B. Along the fluid recirculation path, the fluid enters the fluid-ejection elements 108 from the backside channel 106BC per the points of arrows 116C. The fluid flows through the elements 108 past their nozzles 110 per arrow 116D, before exiting into the element channel 106EC per the tails of arrows 116E. The fluid then flows through the return channel 106EC in the direction of arrow 116F. The fluid exits the return channel 106EC into the element return slot 102ER via the element outlet 104EO per the tail of arrow 116G, completing the fluid-ejection element fluid recirculation path.

FIGS. 1B and 1C show different cross-sectional front views of the fluid-ejection printhead 100 at cross-sectional slots 118B and 118C in FIG. 1A, respectively. FIG. 1B depicts the backside channel fluid recirculation path and a portion of the fluid-ejection element recirculation path, whereas FIG. 1C depicts the remainder of the fluid-ejection element recirculation path. In both FIGS. 1B and 1C, the fluid-ejection printhead 100 includes a supply layer 112L, an interposer layer 112I, a channel layer 112C, and a fluid-ejection element layer 112E, which are collectively referred to as the layers 112.

The supply layer 112L includes the supply slot 102S and the return slots 102BR and 102ER. The interposer layer 112I includes the supply inlet 104SI and the backside outlet 104BO per FIG. 1B, and the element outlet 104EO per FIG. 1C. The channel layer 112C includes the backside channel 106BC per FIG. 1B, and the element channel 106EC per FIG. 1C. The fluid-ejection element layer 112E includes the fluid-ejection elements 108 with their respective nozzles 110.

As depicted in FIG. 1B, in the backside fluid recirculation path, fluid flows from the supply slot 102S through the supply inlet 104SI to the backside channel 106BC per the arrow 114B. The fluid then flows through the backside channel 106BC per the arrow 114C. The fluid finally flows through the backside outlet 104BO into the backside return slot 102BR per the arrow 114D, completing the fluid recirculation path.

As depicted in FIG. 1B, the fluid-ejection element fluid recirculation path may begin with fluid entering the backside channel 106BC through the supply inlet 104SI per the arrow 116B. The fluid flows into the fluid-ejection elements 108 per the arrows 116C, and then past their nozzles 110 per the tails of arrows 116D in FIG. 1B and the points of arrows 116D in FIG. 1C. As depicted in FIG. 1C, the fluid recirculation path continues with the fluid flowing into the element channel 106EC from the fluid-ejection elements 108 per the arrows 116E. The fluid flows through the element channel 106EC per the arrow 116F before flowing into the element return slot 102ER through the element outlet 104EO per the arrow 116G, completing the fluid-recirculation path.

FIGS. 1D, 1E, and 1F show different cross-sectional side views of the fluid-ejection printhead 100 at cross-sectional lines 118D, 118E, and 118F in FIG. 1A, respectively. FIG. 1D depicts a portion of each of the backside channel and fluid-ejection element fluid recirculation paths. FIG. 1E depicts the remainder of the backside channel fluid recirculation path, whereas FIG. 1F depicts the remainder of the fluid-ejection element fluid recirculation path. As in FIGS. 1B and 1C, the supply layer 112L, the interposer layer 1121, the channel layer 112C, and the fluid-ejection element layer 112E are shown in FIGS. 1D, 1E, and 1F.

In the backside channel fluid recirculation path, as depicted in FIG. 1D, fluid flows from the supply slot 102S through the supply inlet 104SI to the backside channel 106BC per the arrow 114B. The fluid then flows through the backside channel 106BC per the tail of arrow 114C in FIG. 1D and the point of arrow 114C in FIG. 1E. As depicted in FIG. 1E, the fluid exits the backside channel 106BC through the backside outlet 104B into the backside return slot 102BR per the arrow 114D, completing the fluid recirculation path.

In the fluid-ejection element fluid recirculation path, as depicted in FIG. 1D, fluid flows from the supply slot 102S through the supply inlet 104SI to the backside channel 106BC per the arrow 116B. The fluid flows into the fluid-ejection elements 108 per the arrow 116C, and then past their nozzles 110 per the arrow 116D in FIGS. 1D and 1F. The fluid flows into the element channel 106EC from the fluid-ejection elements 108 per the arrow 116E in FIGS. 1D and 1F, before flowing through the element channel 106EC per the tail of arrow 116F in FIG. 1D and the point of arrow 116F in FIG. 1F. As depicted in FIG. 1F, the fluid then flows into the element return slot 102ER through the element outlet 104EO per the arrow 116G, completing the fluid-recirculation path.

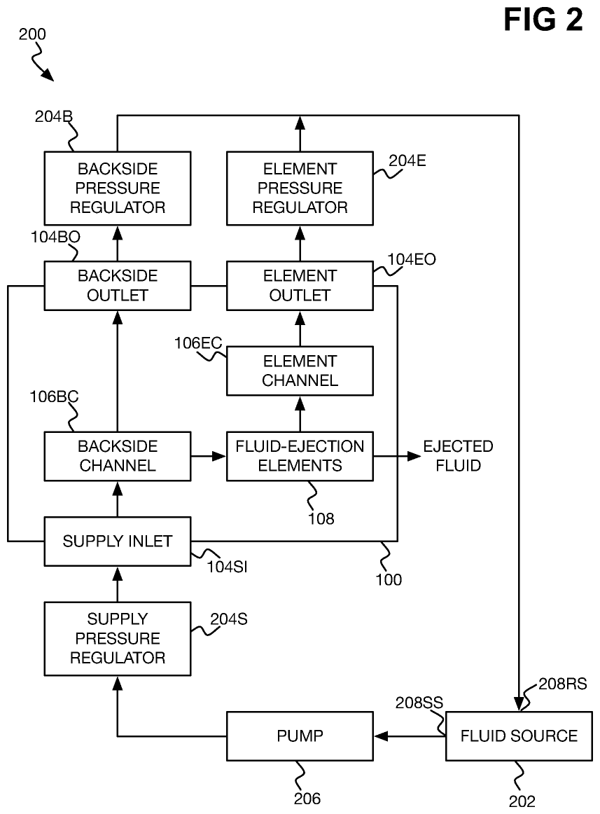

FIG. 2 shows an example fluid-ejection device 200. The fluid-ejection device 200 includes the fluid-ejection printhead 100 that has been described. As specifically called out in FIG. 2, the printhead 100 includes backside and element channels 106BC and 106EC, as well as fluid-ejection elements 108. The backside channel 106BC is fluidically connected between the supply inlet 104SI and the backside outlet 104BO of the printhead 100, as well as to the fluid-ejection elements 108. The element channel 106EC is fluidically connected between the fluid-ejection elements 108 and the element outlet 104EO of the printhead 100.

The fluid-ejection device 200 includes pressure regulators 204S, 204B, and 204E, which are collectively referred to as the pressure regulators 204. The pressure regulator 204S is a supply pressure regulator 204S that regulates or controls the fluid pressure at the supply inlet 104SI. The pressure regulator 204B is a backside channel pressure regulator 204B that regulates or controls the fluid pressure at the backside outlet 104BO is regulated. The pressure regulator 204E is an element pressure regulator 204E that regulates or controls the fluid pressure at the element outlet 104EO.

The fluid-ejection device 200 can include a pump 206, and may also include or otherwise be fluidically connected to a fluid source 202. The pump 206 pumps fluid from a supply side 208SS of the fluid source 202 through the printhead 100, from which the fluid returns to a return side 208RS of the fluid source 202. The supply pressure regulator 204S thus regulates the pressure at which the supply inlet 104SI is fluidically coupled to the supply side 208SS of the fluid source 202 via the pump 206. The pressure regulators 204B and 204E similarly respectively regulate the pressures at which the outlets 104BO and 104EO are fluidically coupled to the return side 208RS of the fluid source 202.

The flow rates of the backside channel fluid recirculation path through the backside channel 106BC and the fluid-ejection element fluid recirculation path through the fluid-ejection elements 108 are independently controllable via corresponding pressure regulation at the supply inlet 104SI, the backside outlet 104BO, and the element outlet 104EO. Specifically, the flow rate of the backside channel fluid recirculation path is dependent on the supply pressure at the supply inlet 104SI and the backside pressure at the backside outlet 104BO. The flow rate of the fluid-ejection element fluid recirculation path is similarly dependent on the supply pressure at the supply inlet 104SI and the element pressure at the element outlet 104EO.

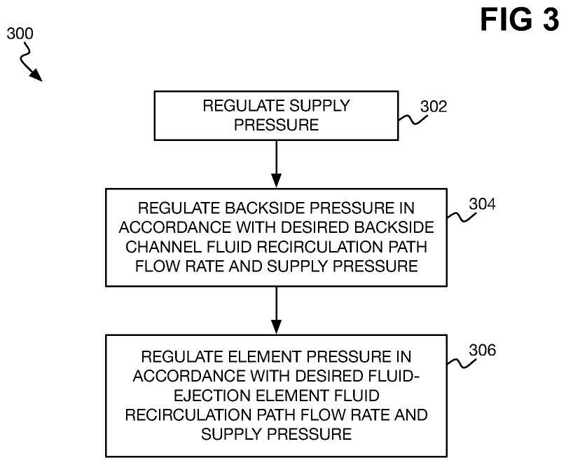

FIG. 3 shows a method 300 for operating the fluid-ejection device 200 having the fluid-ejection printhead 100 with dual fluid recirculation paths. The method 300 includes regulating the supply pressure at which the supply inlet 104SI of (e.g., fluidically connected to) the backside channel 106BC is fluidically coupled to the supply side of 208SS of the fluid source 202 through the pump 206 (302). The supply pressure may be set sufficiently high to attain desired flow rates of both the backside channel fluid recirculation path and the fluid-ejection element fluid recirculation path.

The method 300 includes regulating the backside pressure at which the backside outlet 104BO of (e.g., fluidically connected to) the backside channel 106BC is fluidically coupled to the return side 208RS of the fluid source 202 (304). The backside pressure is regulated (e.g., set) according to a desired flow rate of fluid through the backside channel fluid recirculation path, taking into account the supply pressure set at the supply inlet 104SI. In other words, for a given architecture of the fluid-ejection printhead 100, the backside pressure at the backside outlet 104BO can be set to realize a desired backside channel fluid recirculation path flow rate for a particular supply pressure at the supply inlet 104SI.

The method 300 similarly includes regulating the element pressure at which the element outlet 104EO of (e.g., fluidically connected to) the element channel 106EC is fluidically coupled to the return side 208RS of the fluid source 202 (306). The element pressure is regulated (e.g., set) according to a desired flow rate of fluid through the fluid-ejection element fluid recirculation path, taking into account the supply pressure set at the supply inlet 104SI. In other words, for a given architecture of the fluid-ejection printhead 100, the element pressure at the element outlet 104EO can be set to realize a desired fluid-ejection element fluid recirculation path flow rate for a particular supply pressure at the supply inlet 104SI.

While the regulated pressure at the supply inlet 104SI affects the flow rates of both fluid recirculation paths, the flow rates are nevertheless separately controllable. This is because the backside channel and fluid-ejection element fluid recirculation paths have respective separate outlets 104BO and 104EO from the printhead 100 back to the fluid source 202. Separate regulation of the pressures at the outlets 104BO and 104EO thus permits the flow rates of fluid through the fluid recirculation paths to be set (e.g., controlled) independently of one another, so long as there is sufficient supply pressure at the supply inlet 104SI.

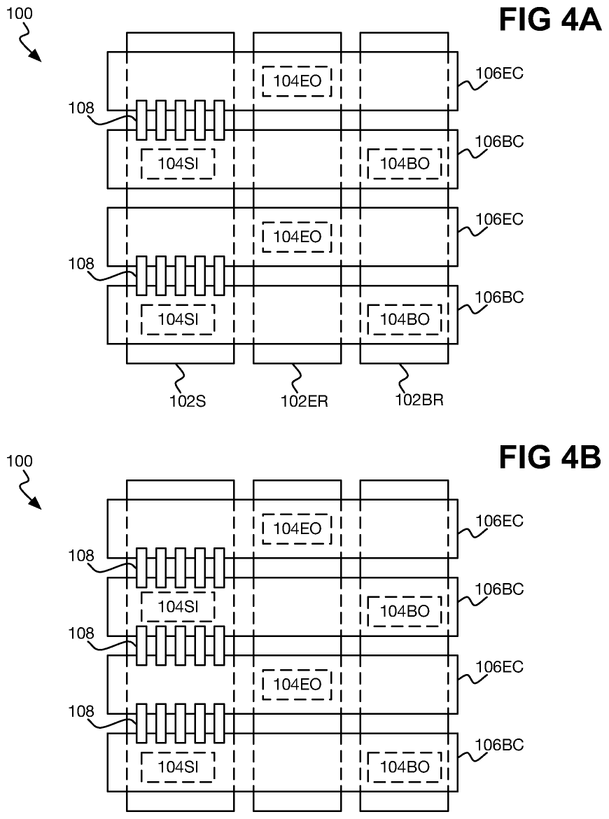

FIGS. 4A and 4B show top-view diagrams of different example topologies for the fluid-ejection printhead 100 that has been described. Both FIGS. 4A and 4B depict the printhead 100 as including two backside channels 106BC and two element channels 106EC. In actual implementation, the printhead 100 may likely include more than two backside channels 106BC and two element channels 106EC. Each backside channel 106BC has a supply inlet 104SI fluidically connected to the supply slot 102S and a backside outlet 104BO fluidically connected to the backside return slot 102BR. Each element channel 106EC has an element outlet 104EO fluidically connected to the element return slot 102ER.

In FIG. 4A, each backside channel 106BC has one corresponding row of fluid-ejection elements 108 to which it is fluidically connected, and likewise each element channel 106EC has one corresponding row of fluid-ejection elements 108 to which it is fluidically connected. Stated another way, each backside channel 106BC is connected to just one row of fluid-ejection elements 108, as is each element channel 106EC. Every fluid-ejection element 108 connected to a given backside channel 106BC is connected to the same element channel 106EC.

By comparison, in FIG. 4B, each backside channel 106BC can have up to two corresponding rows of fluid-ejection elements 108 to which it is fluidically connected, and likewise each element channel 106EC can have up to two corresponding rows of fluid-ejection elements to which it is fluidically connected. Each backside channel 106BC can thus be connected to up to two rows of fluid-ejection elements 108, as is each element channel 106EC. The fluid-ejection elements 108 connected to a given backside channel 106BC can therefore be connected to different element channels 106EC.

FIGS. 4A and 4B show each row of fluid-ejection elements 108 having five such elements 108. In actual implementation, however, each row may likely have more than five fluid-ejection elements 108. Furthermore, the nozzles of the fluid-ejection elements 108 are not depicted in FIGS. 4A and 4B for illustrative clarity.

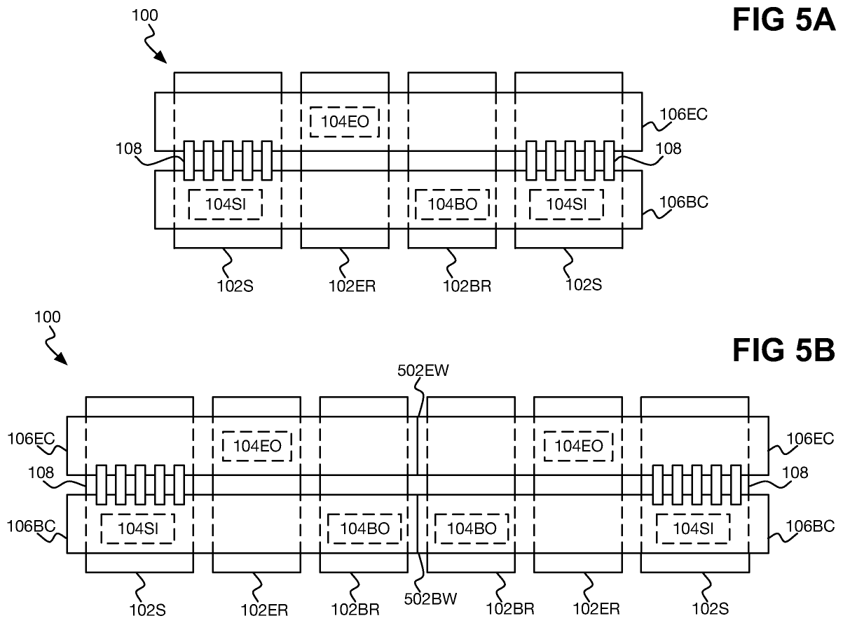

FIGS. 5A and 5B show top-view diagrams of example topologies for the fluid-ejection printhead 100 that differ from one another in another way as compared to FIGS. 4A and 4B. FIGS. 5A and 5B can each be implemented in conjunction with either of FIGS. 4A and 4B. Both FIGS. 5A and 5B depict the printhead 100 as including one backside channel 106BC and one element channel 106EC, but in actual implementation may likely include more than one of each channel type. Both FIGS. 5A and 5B depict the fluid-ejection printhead 100 as having a row of ten fluid-ejection elements 108 spanning the channels 106BC and 106EC. In actual implementation, the printhead 100 may include more than ten fluid-ejection elements 108. The nozzles of the fluid-ejection elements 108 are again not depicted in FIGS. 5A and 5B for illustrative clarity.

In FIG. 5A, the printhead 100 includes two supply slots 102S, one backside return slot 102BR, and one element return slot 102ER. The backside channel 106BC is fluidically connected to each supply slot 102S via a corresponding supply inlet 104SI, and to the backside return slot 102BR via one backside outlet 104BO. The element channel 106EC is fluidically connected to the element return slot 102ER via one element outlet 104EO. Fluid thus enters the printhead 100 at two supply slots 102, but exits the printhead 100 at one backside return slot 102BR and at one element return slot 102ER via one element outlet 104EO. The supply slots 102 can both be connected to the supply side of the same fluid source, such as printing fluid (e.g., ink) of a specific color, with the return slots 102BR and 102ER connected to the return side of this fluid source.

In FIG. 5B, the printhead 100 includes two supply slots 102S, two backside return slots 102BR, and two element return slots 102ER. The backside channel 106BC is fluidically separated into left and right portions, via a backside wall 502BW. The left portion of the backside channel 106BC is connected to the left supply slot 102S via a corresponding supply inlet 104SI, and similarly the right portion of the backside channel 106BC is connected to the right supply slot 102S via a corresponding supply inlet 104SI. The supply slots 102S and thus the supply inlets 104SI can be fluidically connected to the supply sides of different fluid sources, such as printing fluids (e.g., inks) of two different colors. Cross contamination does not occur within the backside channel 106BC because its left and right portions are fluidically separated from one another.

The left portion of the backside channel 106BC is connected to the left backside return slot 102BR via a corresponding backside outlet 104BO, and similarly the right portion of the backside channel 106BC is connected to the right backside return slot 102BR via a corresponding backside outlet 104BO. The backside return slots 102BR and thus the backside outlets 104BO can be fluidically connected to the return sides of different fluid sources in FIG. 5B. Cross contamination again does not occur within the backside channel 106BC because its left and right portions are fluidically separated from one another.

The element channel 106EC is also fluidically separated into left and right portions, via an element wall 502EW. The left portion of the element channel 106EC is connected to the left element return slot 102ER via a corresponding element outlet 104EO, and similarly the right portion of the element channel 106EC is connected to the right element return slot 102EO via a corresponding element outlet 104EO. The element return slots 102ER and thus the element outlets 104EO can be fluidically connected to the return sides of different fluid sources in FIG. 5A. Cross contamination does not occur within the element channel 106EC because its left and right portions are fluidically separated from one another.

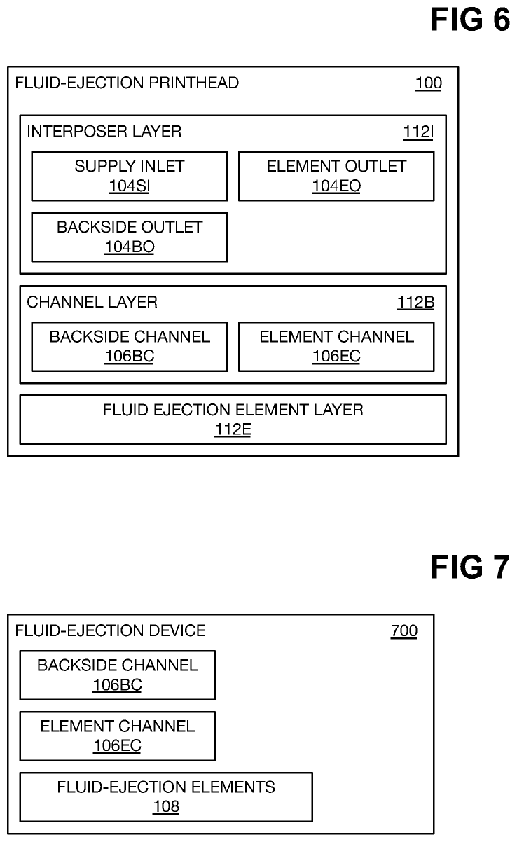

FIG. 6 shows an example fluid-ejection printhead 100 of a fluid-ejection device. The printhead 100 includes an interposer layer 112I defining a supply inlet 104SI, a backside outlet 104BO, and an element outlet 104EO. The printhead 100 includes a channel layer 112B above the interposer layer 112I and having a backside channel 106BC and an element channel 106EC. The backside channel 106BC is fluidically connected to the supply inlet 104SI and the backside outlet 104BO to define a backside channel fluid recirculation path. The element channel 106EC is fluidically connected to the element outlet 104EO. The printhead 100 includes a fluid-ejection element layer 112E above the channel layer 112B and fluidically connected to the backside channel 106BC and the element channel 106EC to define a fluid-ejection element fluid recirculation path.

FIG. 7 shows an example fluid-ejection device 700. The fluid-ejection device 700 may be or include the fluid-ejection printhead 100, for instance. The fluid-ejection device 700 includes a backside channel 106BC fluidically connected between a supply inlet and a backside outlet. The backside channel 106BC has a backside channel fluid recirculation path. The fluid-ejection device 700 includes an element channel 106EC fluidically connected to an element outlet. The fluid-ejection device 700 includes fluid-ejection elements 108 fluidically connected between the backside channel 106BC and the element channel 106EC. The fluid-ejection elements 108 have a fluid-ejection element fluid recirculation path.

Techniques have been described herein that provide a fluid-ejection printhead having dual fluid recirculation paths with independently settable (e.g., controllable) fluid recirculation flow rates. The printhead has a different outlet for each fluid recirculation path. The pressures at the outlets can thus be separately regulated to provide for separately settable fluid recirculation flow rates within their respective fluid recirculation paths.

We claim:

1. A fluid-ejection printhead of a fluid-ejection device, comprising:
an interposer layer defining a supply inlet, a backside outlet, and an element outlet;
a channel layer above the interposer layer and having a backside channel and an element channel, the backside channel fluidically connected to the supply inlet and the backside outlet to define a backside channel fluid recirculation path, the element channel fluidically connected to the element outlet; and
a fluid-ejection element layer above the channel layer and fluidically connected to the backside channel and the element channel to define a fluid-ejection element fluid recirculation path.

2. The fluid-ejection printhead of claim 1, wherein the backside channel fluid recirculation path is defined from the supply inlet through the backside channel and to the backside outlet.

3. The fluid-ejection printhead of claim 1, wherein the fluid-ejection element fluid recirculation path is defined from the supply inlet; through the backside channel, the fluid-ejection element layer, and the element channel; and to the element outlet.

4. The fluid-ejection printhead of claim 1, wherein the backside channel fluid recirculation path and the fluid-ejection element fluid recirculation path have independently controllable flow rates via corresponding pressure regulation at the supply inlet, the backside outlet, and the element outlet.

5. The fluid-ejection printhead of claim 1, wherein the fluid-ejection element layer comprises a plurality of fluid-ejection elements that eject fluid from the fluid-ejection printhead, each fluid-ejection element spanning the backside and element channels.

6. A fluid-ejection device comprising:
a backside channel fluidically connected between a supply inlet and a backside outlet, the backside channel having a backside channel fluid recirculation path;
an element channel fluidically connected to an element outlet; and
a plurality of fluid-ejection elements fluidically connected between the backside channel and the element channel, the fluid-ejection elements having a fluid-ejection element fluid recirculation path.

7. The fluid-ejection device of claim 6, wherein the backside channel fluid recirculation path is defined from the supply inlet through the backside channel and to the backside outlet.

8. The fluid-ejection device of claim 6, wherein the fluid-ejection element fluid recirculation path is defined from the supply inlet; through the backside channel, the fluid-ejection elements, and the element channel; and to the element outlet.

9. The fluid-ejection device of claim 6, further comprising:
a supply pressure regulator to regulate a supply pressure at which the supply inlet is fluidically coupled to a supply side of a fluid source;
a backside channel pressure regulator to regulate a backside channel pressure at which the backside outlet is fluidically coupled to a return side of the fluid source; and
an element channel pressure regulator to regulate an element channel pressure at which the element outlet is fluidically coupled to the return side of the fluid source.

10. The fluid-ejection device of claim 9, wherein the backside channel fluid recirculation path and the fluid-ejection element fluid recirculation path have independently controllable flow rates via corresponding regulation of the supply, backside channel, and element channel pressures.

11. The fluid-ejection device of claim 9, further comprising:
a pump to pump fluid from the fluid source to the supply inlet.

12. The fluid-ejection device of claim 6, wherein the supply inlet comprises a pair of supply inlets fluidically coupled to a supply side of a fluid source,
wherein the backside outlet comprises one backside outlet fluidically coupled to a return side of the fluid source,
and wherein the element outlet comprises one return outlet fluidically coupled to the return side of the fluid source.

13. The fluid-ejection device of claim 6, wherein the supply inlet comprises a pair of supply inlets fluidically respectively coupled to supply sides of a pair of fluid sources,
wherein the backside outlet comprises a pair of backside outlets fluidically respectively coupled to return sides of the fluid sources,
and wherein the element outlet comprises a pair of return outlets fluidically respectively coupled to the return sides of the fluid sources.

14. A method comprising:
regulating a supply pressure at which a supply inlet of a backside channel of a fluid-ejection device is fluidically coupled to a fluid source;
regulating a backside channel pressure at which a backside outlet of the backside channel is fluidically coupled to the fluid source in accordance with the regulated supply pressure and a desired flow rate of a backside channel fluid recirculation path; and
regulating an element channel pressure at which an element outlet of an element channel of the fluid-ejection device is fluidically coupled to the fluid source in accordance with the regulated supply pressure and a desired flow rate of an fluid-ejection element fluid recirculation path.

15. The method of claim 14, wherein the backside channel fluid recirculation path is defined from the supply inlet through the backside channel and to the backside outlet,
and wherein the fluid-ejection element fluid recirculation path is defined from the supply inlet; through the backside channel, a plurality of fluid-ejection elements of the fluid-ejection device, and the element channel; and to the element outlet.
